(19) United States
(12) Patent Application Publication
(10) Pub. No.: US 2010/0035497 A1
(43) Pub. Date: Feb. 11, 2010

(54) PRODUCTION OF DYED TEXTILE MATERIALS COMPRISING POLYPROPYLENE FIBER

(76) Inventors: Claudia Sierakowski, Seeheim-Jugenheim (DE); Jürgen Cleenewerck, Deerlijk (BE); Jürgen Prüfe, Schwetzingen (DE)

Correspondence Address: CONNOLLY BOVE LODGE & HUTZ LLP, 1875 EYE STREET, N.W., SUITE 1100, WASHINGTON, DC, 20006, US

(21) Appl. No.: 12/515,139

(22) PCT Filed: Nov. 30, 2007
(86) PCT No.: PCT/EP07/63058

§ 371 Date: May 15, 2009

(30) Foreign Application Priority Data
Dec. 1, 2006 (DE) 10 2006 057 221.1

(51) Int. Cl. B32B 27/02; B05D 5/06; D02G 3/04; B32B 5/02; B32B 27/32; B32B 27/36

(52) U.S. Cl. 442/171; 264/78; 428/372

(57) ABSTRACT

A process for producing dyed textile materials comprising polypropylene fiber wherein, first, polypropylene is mixed with a polyester having a melting point in the range from 50 to 200° C. in the melt and processed into undyed polypropylene fiber, the undyed polypropylene fiber is processed into textiles and thereafter the textiles are dyed in aqueous liquor or printed, and also to undyed polypropylene fiber particularly useful for executing the process.

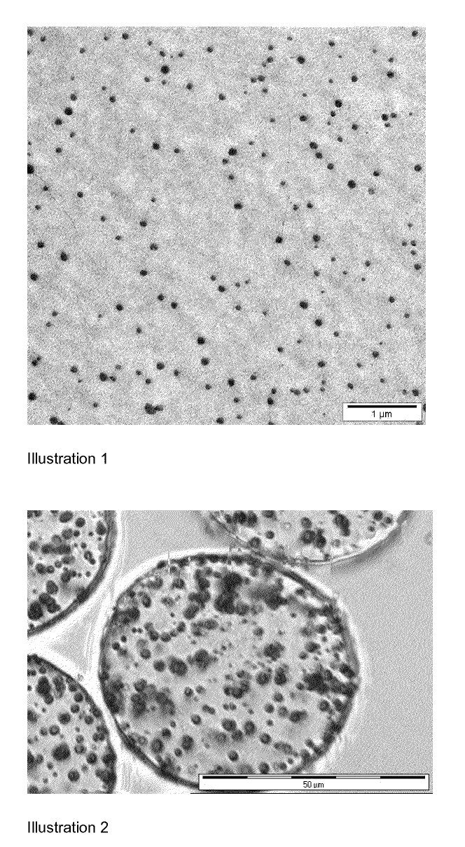

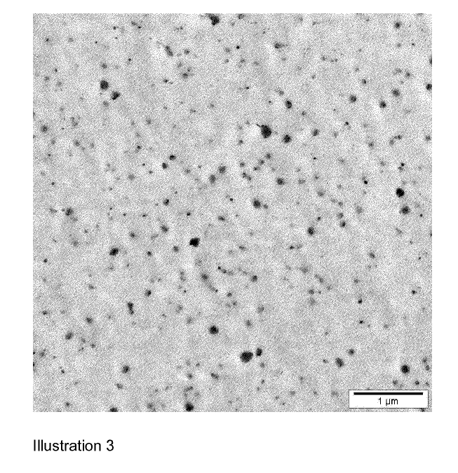

The present invention relates to a process for producing dyed textile materials comprising polypropylene fiber wherein, first, polypropylene is mixed with a polyester having a melting point in the range from 50 to 200° C. in the melt and processed into undyed polypropylene fiber, the undyed polypropylene fiber is processed into textiles and thereafter the textiles are dyed in aqueous liquor or printed, and also to undyed polypropylene fiber particularly useful for executing the process.

Polypropylene is a polymer that is outstandingly useful for producing textile materials. It is simple to process by melt extrusion into fibers and is notable in fiber form for numerous good properties such as low specific density, high breaking strength, high stability to chemicals, low wettability by polar media, low water imbibition or good recyclability as well as for low cost.

Textile materials composed of polypropylene, however, are very difficult to dye from aqueous baths because of the apolar character of polypropylene. To achieve deep shades on polypropylene, it has hitherto been customary to use what is known as mass coloration. In mass coloration, the color-conferring pigment or the dye is added directly to the polypropylene melt in the course of fiber production by melt extrusion and melt spinning. This does indeed provide useful colorations, but startup of the plant and also a change in color require long lead times, associated with correspondingly large amounts of waste, until the plant runs uniformly. Therefore, only the production of large batches makes economic sense. Comparatively small batches, for example for fashion-based color requirements, cannot be produced economically or in short time frames. Nor are bright hues easy to achieve.

The poor post-extrusion dyeability has hitherto militated against a wider use of polypropylene fiber in the textile sector. Thus, despite its inherently favorable properties for use as apparel fiber, in particular for the sector of sports and leisure apparel, polypropylene fiber is rarely used for that purpose.

There has therefore been no shortage of attempts to improve the post-extrusion dyeability of polypropylene from aqueous dyebaths by addition of suitable auxiliaries.

U.S. Pat. No. 4,166,079 discloses the use of an aminated ethylene-glycidyl acrylate copolymer in polyolefins to improve their dyeability. The copolymer is preferably used in an amount of 5% to 13% by weight, based on the entire mixture.

U.S. Pat. No. 5,550,192 and U.S. Pat. No. 5,576,366 disclose the production of dyeable polypropylene fiber wherein an ethylene copolymer of 70% to 82% by weight ethylene and 30% to 18% by weight alkyl acrylate is used as an auxiliary. The mixture may further comprise polyester.

U.S. Pat. No. 6,679,754 discloses the use of polyetheresteramides in polyolefins to improve their dyeability.

US 2005/0239927 discloses a process for producing dyed polyolefin fiber wherein, first, polypropylene is blended with a polymer selected from the group consisting of polyamides, polyamide copolymers and polyetheramides and also with a second polymer (ethylene-vinyl acetate copolymer) and also further additives and then dyed with disperse dyes in aqueous liquor.

US 2005/0239961 discloses the use of branched acrylic acid-polyether copolymers in polyolefins to improve their dyeability.

WO 2005/054309 discloses a polyolefin composition consisting of a continuous polyolefin phase and a discontinuous polyacrylate phase, the polyacrylate being in the form of nanoparticles finely dispersed in the continuous polyolefin phase.

WO 2006/064732 discloses a dyeable polypropylene composition made up of 85% to 96% by weight polypropylene, 3% to 9% by weight of an ethylene-vinyl acetate copolymer and also 2% to 6% by weight of a polyetheresteramide copolymer.

WO 2006/098730 discloses a disperse-dyeable fiber comprising a mixture of a polyolefin with an amorphous, glycol-modified PET (PET-G). Maleic anhydride is preferably used as an additional auxiliary.

Our prior application PCT/EP2006/062469 discloses a process for dyeing polyolefins which comprises utilizing polyolefins blended with a block copolymer comprising at least one apolar block constructed essentially of isobutene units and also at least one polar block constructed essentially of oxyalkylene units. Polyesters and/or polyamides may be incorporated alongside the polyolefin.

It is an object of the present invention to provide an improved process for post-extrusion dyeing of undyed textile materials composed of polypropylene with aqueous dyebaths. Homogeneous, intensive and stripiness-free dyeings should be obtained in particular.

We have found that this object is achieved, surprisingly, on using polyesters having a melting point below that of PET to obtain readily dyeable polypropylene fibers even without an additional compatibilizer.

The present invention accordingly provides a process for producing a dyed textile material comprising polypropylene fiber, the process comprising at least the steps of:
(1) producing undyed fiber comprising essentially polypropylene, by melting polypropylene and intensively mixing the polypropylene with polymeric addition materials and also optionally further added materials in the melt, followed by spinning from the melt,
(2) processing the fiber obtained into an undyed textile material comprising polypropylene fiber and also optionally fiber other than polypropylene fiber,
(3) dyeing the undyed textile material by
   treatment with a formulation comprising at least water and a dye, the textile material being heated during and/or after the treatment to a temperature above the glass transition temperature T_{g} of the polypropylene fiber but below its melting temperature, or
   printing with a print paste at least comprising a dye and also further components, the textile material being heated during and/or after the printing to a temperature above the glass transition temperature T_{g} of the polypropylene fiber but below its melting temperature,
wherein the undyed polypropylene fiber comprises at least the following components:
(A) 80% to 99% by weight, based on the sum total of all constituents of the fiber, of at least one polypropylene having an MFR melt flow rate (230° C., 2.16 kg) of 0.1 to 60 g/10 min, and
(B) 1% to 20% by weight of at least one polyester having a melting point of 50 to 200° C. comprising at least dicarboxylic acid units (B1) and diol units (B2),
   (B1) the dicarboxylic acid units (B1) comprising at least
      (B1a) 5 to 80 mol % of terephthalic acid units and also
      (B1b) 20 to 95 mol % of units from aliphatic 1,ω)-dicarboxylic acids having 4 to 10 carbon atoms,
   the total amount of (B1a) and (B2a) being at least 80 mol %, the % ages each being based on the total amount of all dicarboxylic acid units,
   (B2) the diol units (B2) comprising aliphatic, cycloaliphatic and/or polyether diols and at least
      (B2a) 50 to 100 mol % of aliphatic 1,ω)-diols having 4 to 10 carbon atoms being present, the % age being based on the total amount of all diols, and
the polypropylene and the polyester being mixed with each other in the melt such that the polyester forms a dispersion in the polypropylene of discrete droplets having an average particle size of less than 500 nm.

The present invention further provides undyed polypropylene fiber of the composition described.

The invention will now be described in detail.

Process step (1) comprises producing undyed fiber consisting essentially of polypropylene by intensive mixing of at least the components (A) and (B) in the melt.

### Polypropylene (A)

Suitable polypropylene varieties (A) for producing fiber are known in principle to one skilled in the art. They comprise relatively high molecular weight, viscid products which are characterized as usual in terms of their melt flow rate (determined to ISO 1133). According to the present invention, at least one polypropylene having an MFR melt flow rate (230° C., 2.16 kg) of 0.1 to 60 g/10 min is used.

Polypropylene homopolymers can be used. But it is also possible to use polypropylene copolymers which, as well as the propylene, comprise small amounts of other comonomers. Suitable comonomers include in particular other olefins such as for example ethylene and also 1-butene, 2-butene, isobutene, 1-pentene, 1-hexene, 1-heptene, 1-octene, styrene or α-methylstyrene, dienes and/or polyenes. The proportion of comonomers in the polypropylene is generally not more than 20% by weight and preferably not more than 10% by weight. The comonomers are selected for identity and amount by one skilled in the art according to the properties desired for the fiber. It will be appreciated that a mixture of a plurality of different varieties of polypropylene can be used as well. The polypropylenes preferably have an MFR melt flow rate (230° C., 2.16 kg) of 1 to 50 g/10 min, more preferably of 10 to 45 g/10 min and for example of 30 to 40 g/10 min.

The amount of polypropylene is 80% to 99% by weight, based on the sum total of all constituents of the entire fiber, preferably 85% to 99% by weight, more preferably 90% to 98% by weight and for example 93% to 97% by weight.

### Polyester (B)

The undyed fiber further comprises 1% to 20% by weight of at least one polyester (B). The polyester comprises a polyester having a melting point of 50 to 200° C. Compared with PET, such polyesters have additional soft segments.

The polyesters (B) used according to the present invention for producing the fiber comprise at least dicarboxylic acid units (B1) and diol units (B2). They may additionally comprise further components, such as chain extenders for example.

The polyesters (B1) have at least two different dicarboxylic acid units (B1). They comprise at least 5 to 80 mol % of terephthalic acid units (B1a) and also 20 to 95 mol % of units from aliphatic 1,ω)-dicarboxylic acids (B1b) having 4 to 10 carbon atoms. The total amount of (B1a) and (B2a) is at least 80 mol %, the % ages each being based on the total amount of all dicarboxylic acid units in the polyester.

The aliphatic 1,ω-dicarboxylic acid units (B1b) may comprise for example succinic acid, glutaric acid, adipic acid or sebacic acid. Adipic acid is preferred.

Dicarboxylic acid units other than the dicarboxylic acid units (B1a) and (B1b) can be present alongside the dicarboxylic acid units (B1a) and (B1b). Other aromatic dicarboxylic acid units and/or cycloaliphatic dicarboxylic acid units may be mentioned by way of example. It will be appreciated that mixtures of various dicarboxylic acid units can be used as well.

Preferably the amount of terephthalic acid units (B1a) is 20 to 70 mol % and the amount of (B1b) is 30 to 80 mol %. Preferably the sum total of (B1a) and (B1b) is at least 90 mol %, more preferably at least 98 mol % and most preferably 100 mol %.

The diol units (B2) are selected from the group of the aliphatic cycloaliphatic and/or polyether diols provided at least 50 to 100 mol % of aliphatic 1,ω)-diols (B2a) are present, the % ages being based on the total amount of all diols.

The aliphatic diols having 4 to 10 carbon atoms (B2a) may comprise for example 1,4-butanediol, 1,5-butanediol or 1,6-hexanediol. (B2a) preferably comprises 1,4-butanediol.

Examples of polyether diols comprise diethylene glycol, triethylene glycol, polyethylene glycol or polypropylene glycol. Examples of cycloaliphatic diols comprise cyclopentanediols or cyclohexanediols. It will be appreciated that aliphatic diols not conforming to the (B2a) definition can be used as well. Examples comprise in particular ethylene glycol or propylene glycol.

It will be appreciated that the polyesters may comprise still further components to fine-tune their properties. Examples comprise building units having additional functional groups. Amino groups are to be mentioned here in particular. A further mention must go to building block components for chain extension.

It is a feature of the present invention that the invention is embodied using polyesters (B) having a melting point of 50 to 200° C. The melting point is preferably 60 to 180° C., more preferably 80 to 160° C., most preferably 100 to 150° C. and for example 110-130° C.

The glass transition temperature is preferably 20-35° C., preferably 25-30° C., without any intention of the invention hereby being restricted thereto.

The number average molecular weight Mₙ shall be in general 5000 to 50 000 g/mol and preferably 10 000 to 30 000 g/mol. The range from 20 000 to 25 000 g/mol will be found particularly useful. The M_{w}/Mₙ ratio is preferably in the range from 3 to 6, for example in the range from 4 to 5. It may further be advantageous for the polyester (B) to have an MFR melt flow rate of 2-6 g/10 min (ISO 1133, 190° C., 2.16 kg). A preferred mass density is 1.2-1.35 g/cm³ and more preferably 1.22-1.30 g/cm³. The preferred Vicat softening temperature is 75 to 85° C. and more preferably 78-82° C. (VST A/50, ISO 306).

The production of polyesters (B), typical reaction conditions and catalysts will be known in principle to one skilled in the art. The dicarboxylic acid units to synthesize the polyesters can be used as will be known in principle as free acids or in the form of customary derivatives, as in the form of esters for example. Typical esterification catalysts can be used. One advantageous version of the reaction comprises presynthesizing polyester diol units which can then be linked together by means of suitable chain extenders, by means of diisocyanates for example. This makes it possible to synthesize block copolymers when using different polyester diols. Via the choice of the building block components and/or of the reaction conditions, a person skilled in the art is easily able to conform the properties of the polyesters to a certain profile of requirements. Suitable polyesters (B) are also commercially available.

It will be appreciated that a mixture of a plurality of different polyesters can be used as well.

According to the present invention, the undyed fiber comprises 1% to 20% by weight of at least one polyester (B), based on the sum total of all constituents of the undyed fiber. The amount of polyester (B) is preferably 1% to 15% by weight, more preferably 2% to 10% by weight and for example 3% to 7% by weight.

### Further Components

The undyed fiber, as well as the components (A) and (B), may optionally further comprise small amounts of polymers (C) other than the components (A) and (B). Such additions of further polymers (C) can be used to fine-tune the properties of the fiber. They comprise for example homopolymers or copolymers comprising ethylene, propylene, 1-butene, 2-butene, isobutene, 1-pentene, 1-hexene, 1-heptene, 1-octene, styrene or α-methylstyrene as monomers. Preferably they comprise polyolefins comprising C₂- to C₄-olefins as main constituent. To be mentioned here in particular are polyethylene or polyethylene copolymers or else polypropylene or polypropylene copolymers which do not conform to the definition of component (A). Further polymers (C) may further comprise polymers comprising oxygen and/or nitrogen atoms. One skilled in the art will make a suitable selection according to the properties desired for the fiber. Preferably, no further polymers (C) are present.

The undyed fiber may optionally further comprise further typical additive materials and auxiliaries (D). Examples of (D) comprise antistats, stabilizers, UV absorbers, radical scavengers or antioxidants or else small amounts of fillers. Such additive materials will be known to one skilled in the art. Details are given for example in “Polyolefine” Ullmann's Encyclopedia of Technical Chemistry, 6th Edition, 2000, Electronic Release.

In a particularly preferred embodiment of the present invention, block copolymers composed of at least one apolar block constructed essentially of isobutene units and also at least one polar block comprising oxygen and/or nitrogen atoms shall be excluded for use as component (C) and/or (D).

The amount of further polymers (D) and/or of additive materials and auxiliaries (E)—if present at all—is not more than 19% by weight based on the amount of all components of the fiber, and should generally not exceed 15% by weight, preferably 10% by weight and more preferably 5% by weight.

### Process Step (1)

Process step (1) comprises mixing the components (A) and (B) and also optionally further polymers (C) and/or additive materials and auxiliaries (D) intensively with one another, initially by heating until molten, by means of suitable apparatuses. Kneaders, single-screw extruders, twin-screw extruders or other mixing or dispersing assemblies can be used for example. One preferred embodiment of the present invention comprises using twin-screw extruders.

Polypropylene (A) and polyester (B) are preferably metered by means of appropriate metering devices as pellet into the mixing assembly. It will be appreciated that it is also possible to use premixed pellet.

The mixing is effected such that the polyester (B) forms a dispersion in the polypropylene (A) of discrete droplets having an average particle size of 20 to 500 nm. A droplet size of 80 to 400 nm is preferred. This size is based on the determination by means of a fiber cross-section, i.e., a section perpendicular to the fiber longitudinal axis. In the course of dyeing or printing, the dyes are preferentially taken up by the droplets.

The droplets should preferably be round and have a narrow particle size distribution. The polyester/polypropylene interfacial area must not become too large for a given particle diameter due to irregular droplet shape. Small droplets are desirable because of better spinning in the case of fibers less than 5 dtex/filament. A middling value of 90-170 nm will prove particularly advantageous with regard to spinning performance.

One skilled in the art can particularly influence the size of the droplets of polyester (B) through the intensity of mixing and also through the viscosity conditions in the mixing assembly.

The mixing temperature is chosen by one skilled in the art and depends on the identity of components (A) and (B). The polypropylene and the further components should sufficiently soften to enable commixing. On the other hand, they should not become too liquid, since otherwise sufficient input of shearing energy is no longer possible and, what is more, thermal degradation may possibly occur. In general, the mixing is carried out at a product temperature of 160 to 230° C. and preferably 160 to 190° C., without any intention that the invention should be restricted thereto. The temperature of the heating jacket of the mixing assemblies used is—as one skilled in the art knows in principle—generally somewhat higher.

After mixing, the melt is spun to form undyed fiber. To spin fiber, the molten mass is pressed in a principally known manner through one or preferably more dies, for example an appropriate breaker plate, to form corresponding filaments. A die temperature of 220° C. to 260° C. will be found to be advantageous to spin the mixtures used according to the present invention. The fiber or filaments should generally have a diameter of less than 25 μm. The diameter is preferably 10 to 15 μm, without the invention being restricted thereto. In general, the yarns consist of a plurality of filaments, for example 10 to 200 filaments in the case of total yarn linear densities of 30 to 4000 dtex (dtex≡g/10 km of fiber). A proven filament linear density is 1-8 dtex per filament in the case of the apparel industry and 10-50 dtex/filament in the case of the carpet industry.

It is also possible to produce a filament from a plurality of polymers in a defined geometric arrangement by melt-spinning the polymeric material used according to the present invention and some other material, PET for example, through the die plate in an appropriate arrangement.

One preferred embodiment of the process comprises initially producing a concentrate of the components (A) and (B) and also optionally (C) and/or (D). The mixing techniques and conditions already described can be used. It will be advantageous to choose the ratio of the volumes of polypropylene (A) and polyester (B) such that it is greater than 1. Given densities of about 0.9 g/cm³ for polypropylene and about 1.2 to 1.3 g/cm³ for the polyester, at least about 45% by weight and preferably about 50% by weight of polypropylene (A) should be used.

One preferred embodiment of the present invention comprises using a corotatory twin-screw extruder for producing a concentrate. The two polymers (A) and (B) are preferably first melted in the extruder. Downstream of the point of addition the screw has a plurality of homogenizing zones made up of mixing and shearing parts. This screw construction facilitates a particularly intensive homogenization of the individual components and makes it easy to obtain the desired droplet size. Barrel temperatures are advantageously 160-230° C. and preferably 160-190° C., and preferably decrease somewhat toward the die. The homogenized melt of (A) and (B) can be extruded through a die plate, cooled in a waterbath and then pelletized (strand pelletization). But it is also possible to cut the melt into pellets by underwater pelletization directly at the die plate. If necessary, the pellets can subsequently be dried.

The concentrate is then processed in the melt into undyed threads in a second step together with further polypropylene and also optionally further components (C) and/or (D), as described above. Customary apparatus for spinning in the melt can be used. In the spinning process, the droplets preformed in the concentrate are not significantly changed, but are mainly diluted with the polypropylene additionally added.

The two-stage approach has the advantage that the concentrate can be produced using apparatus particularly adapted to optimally mix the components and to set the droplet size, while the threads can be produced using customary melt-spinning apparatus.

The production of the concentrate and the production of the threads can be carried out in the same facility, not only separately but also in-line, or else in different facilities. For instance, the concentrate can be made and sold by a feedstock supplier, while further processing takes place on the premises of a producer of textile materials.

### Process Step (2)

The undyed fiber is processed in process step (2) into undyed textile materials comprising polypropylene fiber produced according to process step (1) and also optionally fiber different therefrom.

The term “textile materials” shall comprise all materials in the entire production chain of textiles. The term comprises any kind of textile finished article, for example clothing of any kind, home textiles, such as carpets, drapes, blankets or furnishings or technical textiles for commercial and industrial purposes or applications in the home, for example cloths or wipes for cleaning or umbrella fabrics. The term further comprises the starting materials, i.e., fibers for textile use such as filaments or staple fibers, and also semi-finished or intermediate articles such as for example yarns, wovens, knits, fibrous nonwoven webs or nonwovens. Processes for producing textile materials will be known in principle to one skilled in the art.

The textile materials can have been produced exclusively from the polypropylene compositions used according to the present invention. But it will be appreciated that they can also be used in combination with other materials, for example polyester or polyamide materials or natural fibers. A combination can take place at various fabrication stages. For instance, filaments composed of a plurality of polymers in a defined geometric arrangement can be produced at the melt-spinning stage. At the yarn-producing stage, fibers composed of other polymers can be incorporated, or fiber blends can be produced from staple fibers. It is further possible to process different yarns together and finally it is also possible for wovens, knits or the like that comprise the polypropylene compositions of the present invention to be bonded to chemically different wovens.

Textile materials preferred according to the present invention comprise in particular textiles for sports and leisure apparel, shower curtains, umbrealla fabrics, carpets or fibrous nonwoven webs.

### Process Step (3)

Process step (3) comprises dyeing the undyed textile materials by treating them with a formulation comprising at least water and a dye. An aqueous formulation for dyeing textile materials is also referred to as a “liquor” by those skilled in the art.

Preferably, the formulation comprises water only. But small amounts of water-miscible, organic solvents may be present as well. Examples of such organic solvents comprise monohydric or polyhydric alcohols, for example methanol, ethanol, n-propanol, i-propanol, ethylene glycol, propylene glycol or glycerol. Ether alcohols are a further possibility. Examples comprise monoalkyl ethers of (poly)ethylene or (poly)propylene glycols such as ethylene glycol monobutyl ether. The amount of such solvents other than water, however, should not exceed in general 20% by weight, preferably 10% by weight and more preferably 5% by weight based on the sum total of all solvents in the formulation or liquor.

The formulation may in principle utilize any known dye whose polarity is sufficient to dissolve in the polyester droplets. Examples comprise cationic dyes, anionic dyes, mordant dyes, direct dyes, disperse dyes, ingrain dyes, vat dyes, metalized dyes, reactive dyes, sulfur dyes, acid dyes or substantive dyes.

The present invention preferably utilizes a disperse dye, a mixture of various disperse dyes or an acid dye or a mixture of various acid dyes.

A person skilled in the art knows what is meant by “disperse dye”. Disperse dyes are dyes with a low solubility in water which are used in disperse, colloidal form for dyeing, in particular for dyeing fibers and textile materials.

The present invention may in principle utilize any desired disperse dye. The disperse dyes utilized may have various chromophores or mixtures thereof. More particularly, they may be azo dyes or anthraquinone dyes. They may further be quinophthalone, naphthalimide, napthoquinone or nitro dyes. Examples of disperse dyes comprise C.I. Disperse Yellow 3, C.I. Disperse Yellow 5, C.I. Disperse Yellow 64, C.I. Disperse Yellow 160, C.I. Disperse Yellow 211, C.I. Disperse Yellow 241, C.I. Disperse Orange 29, C.I. Disperse Orange 44, C.I. Disperse Orange 56, C.I. Disperse Red 60, C.I. Disperse Red 72, C.I. Disperse Red 82, C.I. Disperse Red 388, C.I. Disperse Blue 79, C.I. Disperse Blue 165, C.I. Disperse Blue 366, C.I. Disperse Blue 148, C.I. Disperse Violet 28 or C.I. Disperse Green 9. A person skilled in the art knows all about the nomenclature of dyes. The complete chemical formulae may be looked up in pertinent textbooks and/or databases (for example the Colour Index). Further details concerning disperse dyes and further examples are also discussed at length for example in “Industrial Dyes”, Edt. Klaus Hunger, Wiley-VCH, Weinheim 2003, pages 134 to 158.

It will be appreciated that mixtures of various disperse dyes can be used as well. Combination shades are obtainable in this way. Preference is given to using such disperse dyes as possess good fastnesses and permit a trichromat.

One skilled in the art is familiar with the term “acid dye”. Acid dyes comprise one or more acid groups, for example a sulfonic acid group, or a salt thereof. These may comprise various chromophores or mixtures of chromophores. More particularly, they may be azo dyes. Examples of acid dyes comprise monoazo dyes such as C.I. Acid Yellow 17, C.I. Acid Blue 92, C.I. Acid Red 88, C.I. Acid Red 14 or C.I. Acid Orange 67, disazo dyes such as C.I. Acid Yellow 42, C.I. Acid Blue 113 or C.I. Acid Black 1, trisazo dyes such as C.I. Acid Black 210, C.I. Acid Black 234, metalized dyes such as C.I. Acid Yellow 99, C.I. Acid Yellow 151 or C.I. Acid Blue 193, mordant dyes such as C.I. Mordant Blue 13 or C.I. Mordant Red 19 or acid dyes having various other structures such as C.I. Acid Orange 3, C.I. Acid Blue 25 or C.I. Acid Brown 349. Further details concerning acid dyes and further examples are also discussed at length for example in “Industrial Dyes”, Edt. Klaus Hunger, Wiley-VCH, Weinheim 2003, pages 276 to 295. It will be appreciated that mixtures of various acid dyes can be used as well.

The amount of dye in the formulation will be decided upon by one skilled in the art according to the intended application.

The formulation, as well as solvents and dyes, may comprise further, auxiliary components. Examples comprise typical textile auxiliaries such as dispersing and leveling agents, acids, bases, buffer systems, surfactants, complexing agents, defoamers or stabilizers against UV degradation. It may be preferable to use a UV absorber as an auxiliary.

Dyeing is preferably done using a neutral or acidic formulation, for example with a pH of 2 to 7 and preferably 4 to 6.

Treating the textile materials with the aqueous dye formulation can be carried out by means of customary dyeing processes, for example by dipping into the formulation, by spraying with the formulation or by coating the formulation by means of suitable apparatus. Processes may be continuous or batch operations. Dyeing apparatus will be known to one skilled in the art. Dyeing may be done for example batchwise using reel becks, yarn-dyeing apparatus, beam-dyeing apparatus or jets, or continuously by slop padding, face padding, spraying or foam-coating processes using suitable drying and/or fixing means.

The weight ratio of the dye formulation to textile materials (also known as “liquor ratio”) and also in particular of the dye to the textile materials is decided by one skilled in the art according to the intended application. The general case is a weight ratio of dye formulation/textile materials in the range from 5:1 to 50:1 and preferably in the range from 10:1 to 50:1 and also a dye quantity in the formulation of about 0.5% to 5% by weight and preferably 1% to 4% by weight based on the textile material without any intention that the invention shall be restricted to this range.

According to the present invention, the textile materials are heated during and/or after the treatment with a dye formulation to a temperature above the glass transition temperature T_{g} of the polypropylene fiber but below its melting temperature. This may be preferably done by heating the entire formulation to the temperature in question and dipping the textile materials into the formulation. A glass transition temperature T_{g} of the polypropylene fiber depends on the identity of the polymeric composition used and can be measured according to processes known to one skilled in the art.

However, it is also possible for the textile materials to be treated with the formulation at a temperature below T_{g}, if appropriate dried and subsequently for the treated textile materials to be heated to a temperature above T_{g}. It will be appreciated that combinations of the two possibilities are possible as well.

The temperature during the treatment does of course depend on the identity of the polypropylene composition used and of the dye used. Temperatures of 90 to 145° C. and preferably 95 to 130° C. will be found advantageous.

The duration of the treatment is determined by one skilled in the art according to the identity of the polymeric composition, of the formulation and also of the dyeing conditions. It is also possible to alter the temperature as a function of the treatment time. For instance, a comparatively low initial temperature in the range from 70 to 100° C. for example may be gradually raised to a temperature in the range from 120 to 140° C. Of proven utility is a heating-up phase of 10 to 90 min and preferably 20 to 60 min and a subsequent high-temperature phase of 10 to 90 min and preferably 20 to 60 min.

One preferred embodiment of the present invention comprises a treatment with steam. This preferably takes the form of a short-time treatment having a duration of about 0.5 to 5 min for example, with steam or with superheated steam.

In the course of the thermal treatment, the dye penetrates the fibers of the textile material to form a dyed textile material. In the fibers, the dye is essentially taken up in the droplets composed of the polyester (B). The polypropylene (A) remains essentially undyed. Owing to the even distribution of the polyester in the form of fine droplets in the polypropylene phase, the fiber becomes both evenly and intensively colored.

Dyeing may be followed by a conventional aftertreatment, for example with laundry detergents or oxidatively or reductively acting afterclearing agents or fastness improvers. Such aftertreatments are known in principle to one skilled in the art.

The color intensity, brilliance and fastness is enhanceable by a treatment with steam in particular. Such a treatment with steam has the advantage that there is no need for an additional aftertreatment with leveling agent or at least the amount of leveling agent used can be distinctly reduced.

In an alternative embodiment of the present invention, the undyed textile material can also be printed. To be useful for printing, a textile material must of course have a sufficient area. Fibrous nonwoven webs, wovens, knits or films can be printed for example. Wovens are preferably used for printing.

Processes for printing textile substrates are in principle known to one skilled in the art. Screen printing or inkjet printing can be used for example.

In one preferred embodiment of the present invention, printing is carried out by screen-printing technology. Textile-printing pastes may be utilized for this purpose in a principally known manner that generally comprise at least a binder, a dye and a thickener and also optionally further additives such as wetting agents, Theological auxiliaries or UV stabilizers for example. The aforementioned dyes can be used as colorants. Disperse or acid dyes are preferred, disperse dyes being particularly preferred. Print pastes for printing textiles and also their customary constituents will be known to one skilled in the art.

The printing process can be carried out as a direct printing process; that is, the print paste is transferred directly to the substrate.

It will be appreciated that one skilled in the art can also effect printing by means of other processes, an example being direct printing using ink jet technology.

According to the present invention, a thermal aftertreatment is carried out in the case of printing as well. To this end, the substrate composed of the textile material used according to the present invention is heated during and/or preferably after printing to a temperature above the glass transition temperature T_{g} of the polypropylene fiber but below its melting temperature.

The printed substrate may preferably be dried first, for example at 50 to 90° C. for a period in the range from 30 seconds to 5 minutes. The thermal treatment is carried out subsequently, preferably at the temperatures already mentioned. The period of time which will be found suitable is that from 30 seconds to 5 minutes in conventional apparatus, examples being atmospheric drying cabinets, tenters or vacuum drying cabinets.

Printing may be followed by a customary aftertreatment as already described above. The textile may further also be subsequently coated in a known manner, for example to improve fabric hand or protect it against abrasion.

Dyeing and printing can be combined with each other, for example by first dyeing a textile material in a certain color and then printing it with a pattern, logo or the like.

The present invention's processes for dyeing and/or printing provide dyed textile materials which, as well as components already described, further comprise dyes, in particular disperse dyes or acid dyes and more preferably disperse dyes. The amount of dye is preferably in the range from 0.5% to 10% by weight and preferably in the range from 1% to 6% by weight, based on the amount of all components of the composition.

Using polyester (B) as an incorporant provides very intensive and even dyeings. The dyeings have very good rub fastnesses and very good wash fastnesses. The examples which follow illustrate the invention.

### Polyester (B) Used

The experiments were carried out using a polyester comprising terephthalic acid units (about 40 mol % based on the amount of all dicarboxylic acid units), adipic acid units (about 60 mol % based on the amount of all dicarboxylic acid units), and also 1,4-butanediol units which was prepared by the procedure described in example 1 of WO 98/12242. Its melting point was 110 to 120° C.

Preparation of a Block Copolymer of ABA Structure from PIBSA 1000 and Polyethylene Glycol 6000

Reaction of PIBSA₁₀₀₀ (hydrolysis number HN=86 mg/gKOH) with Pluriol® E6000 (polyethylene oxide, Mₙ≈6000)

A 4 l three-neck flask equipped with internal thermometer, reflux condenser and nitrogen tap was charged with 783 g of PIBSA (Mₙ=1305; DP=1.5) and 1800 g of Pluriol® E6000 (Mₙ≈6000, DP=1.1). In the course of heating to 80° C., the flask was 3× evacuated and blanketed with N₂. The mixture was subsequently heated to 130° C. and held at this temperature for 3 h. Thereafter, the product was allowed to cool down to room temperature.

### INVENTIVE EXAMPLE 1

### Step 2: Preparation of a Concentrate from Polypropylene and Polyester

A concentrate was prepared using a corotatory twin-screw extruder having a 40 mm screw diameter (ZSK 40) and a length to diameter (L/D) ratio of 33. Initially, a concentrate of 52% by weight of polypropylene (Moplen HP 561S MFR melt flow rate (230° C., 2.16 kg)) and 48% of the above-described polyester (B) was prepared.

Polypropylene and the polyester were metered as pellet into the extruder intake via two metering scales. The two polymers are melted in the extruder at a speed of 150 rpm and a total throughput of 50 kg/h. The barrel temperature was 180° C. directly downstream of the intake and decreased to 150° C. toward the die. Downstream of the point of addition of the polymers, the screw has a plurality of homogenizing zones made up of mixing and shearing parts. This screw construction facilitates a particularly intensive homogenization of the individual components. The homogenized melt was then extruded through a die plate and cut into pellets about 5 mm in size by underwater pelletization directly at the die plate.

### Step 2: Melt Spinning Into Fiber

Melt spinning was done using a customary melt-spinning apparatus in which the material used can first be melted in an extruder and then extruded through a die plate.

A mixture of 10% by weight of the material obtained in the first step and also 90% by weight of further polypropylene (Moplen HP 561S MFR melt flow rate (230° C., 2.16 kg)) was used. The heating temperature for the screw was about 260° C., die plate temperature was about 230° C. 24 filaments of about 3 dtex/filament were spun and processed into 78 dtex fiber (dtex≡g/10 km of fiber).

The fiber obtained consisted of 4.8% by weight of polyester (B) and 95.2% by weight of polypropylene. Illustration 1 shows a cross section through a filament. The polypropylene is dispersed in the fiber in the form of fine droplets about 80 to 200 nm in size.

### COMPARATIVE EXAMPLE 1

Inventive example 1 was repeated except that a commercially available polyethylene terephthalate (PET) having a melting point of about 260° C. was used instead of the polyester used according to the present invention.

In the course of the production of the concentrate, the PET did also become dispersed in the polypropylene phase, but the size of the PET droplets remained in the μm region. The concentrate could therefore not be spun into fine filaments less than 20 dtex/filament in linear density. Only relatively thick filaments were obtainable. 200 dtex 12 filament fiber was produced.

Illustration 2 shows a cross section through filament obtained. The PET is dispersed in the form of droplets, but the size of the PET droplets was 1 to 4 μm

### COMPARATIVE EXAMPLE 2

Inventive example 1 was repeated except that a concentrate of 50% by weight of polypropylene, 40% by weight of the above-described polyester and 10% by weight of an additional block copolymer of ABA structure from PIBSA 1000 and polyethylene glycol 6000 was used. The additional polymer is intended to act as a compatibilizer.

Fiber composed of 5% by weight of PET and 95% by weight of polypropylene and also 1% by weight of the block copolymer was obtained. Illustration 1 shows a cross section through a filament. The polypropylene is dispersed in the fiber in the form of fine droplets about 80 to 200 nm in size. The boundaries between polyester (B) and polypropylene are more strongly smudged than in the case of inventive example 1.

### Production of Textile Fabrics:

The polypropylene fiber of inventive example 1 and comparative example 2 was knit up into textile fabrics which were used for dyeing tests:

Dyeings with Disperse Dyes:

The dyeings were carried out by heating the knits, produced as described above, in demineralized water in the presence of commercially available disperse dyes (Dianix Rubine, SEB; Dianix Black AMB; Dianix Yellow SLG; Teratop Blue GLF) in an amount of 2% by weight on the undyed textile material used, at pH 4.5 in an AHIBA dyeing machine from initially 90° C. to 130° C. over 40 minutes at a heating rate of 1° C./min and leaving them at 130° C. for a further 60 minutes. The liquor ratio, i.e., the ratio of the volume of the treatment bath in liters to the mass of the dry polypropylene-containing knit in kilograms, was 50:1. After dyeing, the dyeings were cooled down to about 90° C., removed, rinsed cold and dried at 100° C. Liquor ratio=1:50.

The dyeing operation produced an intensive coloration of the polyester phase in inventive example 1, while the polypropylene phase did not take up any dyes. The textile material looks evenly colored/dyed, nonetheless. In comparative example 2, there is a region around the polyester which is slightly colored. The overall color impression is the same as in the case of inventive example 1.

The wash fastness and light fastness of the textile materials were rated on scales of 1 to 5. They are each better in the case of inventive example 1 by ½ a rating point than in the case of comparative example 2. The use of additional dispersing assistants is accordingly not necessary in the present invention's use of the polyesters (B).

### Schedule of Illustrations:

Illustration 1: section through a filament from inventive example 1 (4.8% by weight of polyester (B) and 95.2% by weight of polypropylene)
Illustration 2: section through a filament from comparative example 1 (4.8% by weight of PET and 95.2% by weight of polypropylene)
Illustration 3: section through a filament from comparative example 2 (4% by weight of polyester (B), 1% by weight of block copolymer, 95% by weight of polypropylene)

1. A process for producing a dyed textile material comprising polypropylene fiber, the process comprising at least the steps of
(1) producing undyed fiber comprising essentially polypropylene, by melting polypropylene and intensively mixing the polypropylene with a polyester and also optionally further added materials in the melt, followed by spinning from the melt,
(2) processing the fiber obtained into an undyed textile material comprising polypropylene fiber and also optionally fiber other than polypropylene fiber,
(3) dyeing the undyed textile material by
treatment with a formulation comprising at least water and a dye, the textile material being heated during and/or after the treatment to a temperature above the glass transition temperature T_{g} of the polypropylene fiber but below its melting temperature, or
printing with a print paste at least comprising a dye and also further components, the textile material being heated during and/or after the printing to a temperature above the glass transition temperature T_{g} of the polypropylene fiber but below its melting temperature,
wherein the undyed polypropylene fiber comprises at least the following components:
(A) 80% to 99% by weight, based on the sum total of all constituents of the fiber, of at least one polypropylene having an MFR melt flow rate (230° C., 2.16 kg) of 0.1 to 60 g/10 min, and
(B) 1% to 20% by weight of at least one polyester having a melting point of 50 to 200° C. comprising at least dicarboxylic acid units (B1) and diol units (B2),
(B1) the dicarboxylic acid units (B1) comprising at least
(B1a) 5 to 80 mol % of terephthalic acid units and also
(B1b) 20 to 95 mol % of units from aliphatic 1,ω-dicarboxylic acids having 4 to 10 carbon atoms,
the total amount of (B1a) and (B2a) being at least 80 mol %, the % ages each being based on the total amount of all dicarboxylic acid units,
(B2) the diol units (B2) comprising aliphatic, cycloaliphatic and/or polyether diols and at least
(B2a) 50 to 100 mol % of aliphatic 1,ω-diols having 4 to 10 carbon atoms being present, the % age being based on the total amount of all diols, and
the polypropylene and the polyester being mixed with each other in the melt such that the polyester forms a dispersion in the polypropylene of discrete droplets having an average particle size of 20 to 500 nm.

2. The process according to claim 1 wherein the average particle size is 80 to 400 nm.

3. The process according to claim 1 wherein the aliphatic 1,ω-dicarboxylic acid unit (B1b) comprises adipic acid units.

4. The process according to claim 1 wherein the aliphatic 1,ω-diols (B2a) comprise 1,4-butanediol.

5. The process according to claim 1 wherein the amount of (B1a) is 20 to 70 mol % and the amount of (B1b) is 30 to 80 mol %.

6. The process according to claim 1 wherein the polyester (B) comprises chain-extending units as well as (B1) and (B2).

7. The process according to claim 1 wherein the polyester (B) has a number average molecular weight Mₙ of 10 000 to 30 000 g/mol.

8. The process according to claim 1 wherein the melting point of the polyester is 80 to 160° C.

9. The process according to claim 1 wherein the polypropylene fiber further comprises more than 19% by weight of further polymer (C) other than (A) and (B) and/or additive materials and auxiliaries (D).

10. The process according to claim 1 wherein the dye comprises a disperse dye.

11. The process according to claim 1 wherein a concentrate of the components (A) and (B) and also optionally further components (C) and/or (D) is produced in a first step by mixing in the melt, the amount of the polypropylene being 40% to 60% by weight based on the sum total of all components, and the concentrate is processed with additional polypropylene (A) in the melt in a second step into the undyed fiber.

12. An undyed polypropylene fiber comprising at least the following components:
(A) 80% to 99% by weight, based on the sum total of all constituents of the fiber, of at least one polypropylene having an MFR melt flow rate (230° C., 2.16 kg) of 0.1 to 60 g/10 min, and
(B) 1% to 20% by weight of at least one polyester having a melting point of 50 to 200° C. comprising at least dicarboxylic acid units (B1) and diol units (B2),
(B1) the dicarboxylic acid units (B1) comprising at least
(B1a) 5 to 80 mol % of terephthalic acid units and also
(B1b) 20 to 95 mol % of units from aliphatic 1,ω-dicarboxylic acids having 4 to 10 carbon atoms,
the total amount of (B1a) and (B2a) being at least 80 mol %, the % ages each being based on the total amount of all dicarboxylic acid units,
(B2) the diol units (B2) comprising aliphatic, cycloaliphatic and/or polyetherdiols and at least
(B2a) 50 to 100 mol % of aliphatic 1,ω-diols having 4 to 10 carbon atoms being present, the % age being based on the total amount of all diols, and
the polyester forming a dispersion in the polypropylene of discrete droplets having an average particle size of 20 to 500 nm.

13. The undyed polypropylene fiber according to claim 12 wherein the average particle size is 80 to 400 nm.

14-21. (canceled)

22. The undyed polypropylene fiber according to claim 13 wherein the polypropylene fiber further comprises more than 19% by weight of further polymer (C) other than (A) and (B) and/or additive materials and auxiliaries (D).

23. A dyed textile material obtainable by dyeing and/or printing undyed textile material comprising undyed polypropylene fiber according to claim 12, wherein the dye is essentially in the polypropylene phase.

24. The process according to claim 2 wherein the aliphatic 1,ω-dicarboxylic acid unit (B1b) comprises adipic acid units.

25. The process according to claim 2 wherein the aliphatic 1,ω-diols (B2a) comprise 1,4-butanediol.

26. The process according to claim 3 wherein the aliphatic 1,ω-diols (B2a) comprise 1,4-butanediol.

27. The process according to claim 2 wherein the amount of (B1a) is 20 to 70 mol % and the amount of (B1b) is 30 to 80 mol %.

28. The process according to claim 3 wherein the amount of (B1a) is 20 to 70 mol % and the amount of (B1b) is 30 to 80 mol %.
